(19) United States
(12) Patent Application Publication
(10) Pub. No.: US 2006/0261647 A1
(43) Pub. Date: Nov. 23, 2006

(54) Vehicle seat provided with an active suspension with two degrees of freedom of motion

(75) Inventors: Jürgen Maas, Kelkheim (DE); Vasilios Orizaris, Renningen (DE); Hans-Peter Schoner, Modautal-Brandau (DE)

Correspondence Address: FITCH, EVEN, TABIN & FLANNERY, P. O. BOX 65973, WASHINGTON, DC, 20035, US

(73) Assignee: DAIMLERCHRYSLER AG, Stuttgart (DE)

(21) Appl. No.: 10/538,792

(22) PCT Filed: Oct. 28, 2003
(86) PCT No.: PCT/EP03/11923

§ 371 Date: Jul. 27, 2005

(30) Foreign Application Priority Data
Dec. 12, 2002 (DE) 102 58 020.0

(51) Int. Cl. B60N 2/42

(52) U.S. Cl. 297/216.1

(57) ABSTRACT

A vehicle seat provided with an active suspension, comprising:
a resiliently mounted vibration-isolating frame (2),
a seat mechanism (6a, 6b, 8a, 8b, 10, 13), which can be adjusted by means of at least two actuators (4a, 4b) and is articulated on the vibration-isolating frame (2),
at least two acceleration sensors (11, 12), of which the first acceleration sensor is arranged at a spring supporting point in the vicinity of a first joint axis, and the second acceleration sensor is arranged at a spring supporting point in the vicinity of a second joint axis,
and at least two final control elements (S1, S2) and power and control electronics (R1, R2, FFC, E, CU) with which the signals of the acceleration sensors are processed and converted into desired adjusting forces (F*1, F*2), which serve as control commands for the final control elements (S1, S2) for operating the actuators (4a,4b),
so that the vibration-isolating frame (2) can be adjusted by means of the two actuators (4a, 4b) in two degrees of freedom of motion, and the forces which are introduced into the seat from the console of the vehicle chassis are compensated by means of the power and control electronics (R1, R2, FFC, E, CU) in two degrees of freedom of motion.

The invention relates to a vehicle seat for motor vehicles, in particular for passenger cars, but also for trucks or commercial vehicles, provided with an active seat suspension. The active seat suspension uses electrical actuators to counteract vibrations and shocks introduced into the seat from the floor of the vehicle.

The closest prior art is formed by the Japanese patent from the Mitsubishi Motor Corp. JP 09109757. This document discloses an active seat suspension by means of electrical actuators. Vibrations which are introduced into the seat from the floor of the vehicle via the seat underframe are sensed by a vibration sensor. A second acceleration sensor on the seat itself measures the accelerations in the vertical direction occurring at the seat. The signals of the vibration sensor and the signals of the acceleration sensor are processed in a closed-loop control system for the activation of the electrical actuator. The control strategy is therefore to use the electrical actuators to counteract the vibrations introduced into the seat substructure, in order that the seat is changed as little as possible in its vertical position. The controlled system for activating the likewise vertically arranged actuator contains a filter with which low-frequency disturbances are filtered out. According to the structural design of the seat underframe, the active seat suspension is mainly suitable for commercial vehicles.

The aforementioned patent specification works with one degree of freedom of motion and with electrical actuators or damping means arranged in an upright position. Vibrations or shocks introduced into the seat are thereby also actively counteracted only in the vertical direction. Moreover, the vertical arrangement of the actuators requires an overall height of the seat underframe that is available only in relatively large commercial vehicles. Pitching or rolling movements of the seat cannot be counteracted with such an arrangement.

The object according to the invention is therefore to specify a vehicle seat provided with an active suspension of which the actuator system is capable also of counteracting pitching or rolling movements of the seat. Moreover, it is intended that the vehicle seat can be used not only in trucks or commercial vehicles but also in passenger cars.

The object is achieved by a vehicle seat with the features of the independent claim. Further advantageous embodiments are contained in the subclaims and in the description.

The following advantages are mainly achieved by the invention:

The structural design of the seat underframe is configured with lying actuators, which by means of joints make it possible for the vibrations introduced from the underbody to be actively counteracted. The lying arrangement of the actuators makes a significantly reduced overall height of the seat underframe possible, so that the seat can also be fitted and used in passenger cars.

The construction of the seat underframe makes active suspension of the seat possible with two degrees of freedom of motion. In this way it is possible not only, as previously, to counteract vertical accelerations acting on the seat but also to compensate for pitching movements of the vehicle about the transverse axis or rolling movements of the vehicle about the longitudinal axis.

The comfort for the vehicle occupants is increased quite considerably by the vehicle seat proposed here.

The seats in the vehicle represent an essential interface between people and vehicle that is of great relevance to customers. In this respect, the seating comfort is decisively influenced not only by the seat contour and upholstery but by the mechanical oscillations and shocks acting on the passenger, which are the main factors characterizing the subjectively perceived traveling comfort. In spite of continuous improvements to the vehicle chassis and the drive train, the disturbing oscillations, in particular in the upper frequency range, must be absorbed by the seat system.

The aim of the invention is to obtain a noticeable increase in the vibrational comfort, in order to offer innovative solutions also in the future for the premium comfort requirements expected by customers. Since this cannot be achieved with passively sprung seats, because of a largely exhausted potential for optimization, an active seat suspension has been developed, with which a largely dynamic decoupling of the seat from the oscillations and vibration introduced into the seat via the console is achieved.

The special challenge of active seat suspension is the realization of a suitable closed-loop or open-loop control system which on the one hand copes with the stochastic nature of the excitation of oscillations, but on the other hand is distinguished by a high degree of control quality, in closed-loop or open-loop control, even in the case of occupants of different weights and different sitting postures.

To achieve the aim of suppressing oscillations as well as possible, a high-performance control concept with a response that can be variably implemented is proposed, merely requiring the acceleration of the seat as input information.

In the case of the active suspension according to the invention, the selection of an actuator system concept that conforms to the requirements for the passenger compartment of a vehicle is devoted special attention. It is intended to be compact, free from noise and free from leakage. The electrical linear direct drives that have only been on the market for a short time are used. These actuators are distinguished by high dynamics and ensure operation in all four quadrants of the force-speed diagram. This allows almost any desired virtual stiffness and damping to be implemented, making it possible for the response of the seat to be selectively influenced. To minimize the costs and energy consumption, the static seat support takes place by means of a passive suspension 3a, 3b.

The actively suspended seat is realized with allowance for ergonomic aspects (choice of the degrees of freedom) and with the inclusion of crash safety. For this purpose, the overall seat is mounted on a vibration-isolating frame 2 which is movable in two coordinates (lifting and pitching direction or lifting and and rolling direction) and is passively supported by means of four springs. For active vibrational isolation, the electrical linear actuators 4a, 4b described are used, affecting the dynamics of the seat parallel to the points of articulation of the springs via the rotatably mounted angle pieces 6a, 6b. The flat type of construction achieved in this way allows this concept also to be used in a passenger car.

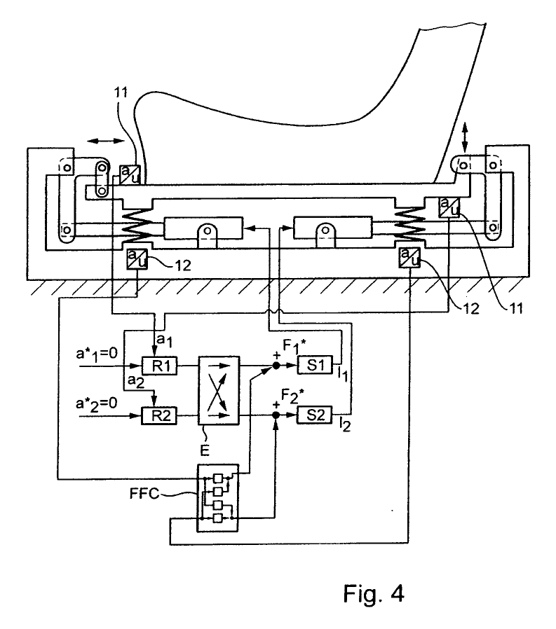

In the most comprehensive configuration of the seat that is shown in FIG. 4, a total of four acceleration sensors are installed in the region of the spring articulation points as the sensor system for the closed-loop or open-loop control, only two of the sensors being required for a closed control loop (one sensor for each degree of freedom).

Representative measurements of seat and occupant accelerations in a driving test and the perceptual response of occupants were used as a basis for establishing the degrees of freedom for which it is primarily to be endeavored to achieve an improvement in vibrational suppression. In this respect, the human body experiences the main element of oscillation to which it is subjected by vertical vibrations and shocks. As a consequence of this, a concept for active seat suspension in the z direction was devised both for the passenger car sector and for the commercial vehicle sector. In particular for passenger cars, the restriction in the overall space in the passenger compartment of the cars requires an active suspension concept which can be realized in an overall space that is as small as possible in the vertical direction. The introduction of the actuator forces at the front and rear points of the console fastening proved to be suitable. This makes it possible for the vertical and pitching dynamics of the seat and occupant to be influenced. With the boundary condition of minimal structural height, the linear actuators 4a, 4b (configured as two-phase synchronous motors) were integrated horizontally in the seat construction and the actuator movement on the driven side was deflected into the vertical direction by a simple mechanism, which takes place by means of rotatably mounted angle pieces 6a, 6b.

To minimize the forces, the passive suspension 3a, 3b undertakes the support of the basic load of the seat and occupant. It is additionally dimensioned in such a way
that the vibration displacement required to compensate for the disturbances is adequately large,
that the bottoming of the suspension is counteracted by a progressive characteristic,
that in the event of failure of the actuators the natural frequency has the otherwise customary value (about 4 Hz).

The linear motors are configured in such a way by feeding electronics that they are current-controlled or force-controlled. The desired force value is generated by the superposed closed-loop or open-loop seat control system and is introduced to the seat as an additive alternating force parallel to the springs.

Information on the state of movement of the car seat is obtained by implementing on the front and rear parts of the movably sprung seat frame a respective acceleration sensor 11a, 11b, the signal of which is fed to the closed-loop or open-loop control system. There are no measuring devices on the surfaces of the seat and backrest cushions, since they proved to be impractical because of the associated deterioration in comfort and significantly higher costs. This missing measurement of the parameter that is actually to be controlled, the acceleration of the occupant, requires the use of suitable models in order to obtain satisfactory suppression of disturbances.

It appears to be advisable for this purpose to install two additional acceleration sensors 12a, 12b on the bottom of the console in the region of the supporting points, which sensors supply information on the oscillation introduced, for optional feedforward compensation.

The configuration of an active suspension for vibration-isolated seats in commercial vehicles is made simpler. Since the approach differs only in terms of geometry and kinematics, but the methodology is identical, the procedure is explained hereafter on the basis of a car seat.

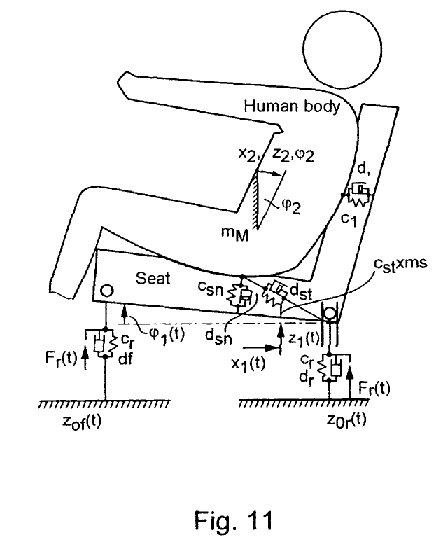

As the basis for designing the closed-loop control system, the dynamic response of the seat and occupant have to be modeled. To describe this, multi-mass oscillators with concentrated coupling elements, comprising springs and dampers, are used. This is based on the simplifying assumption that the continuously distributed mass of the human body behaves like a rigid mass. The mass of the human body is coupled to the mass of the seat visco-elastically by means of the foam elements of the seat cushion and backrest. This results in the dynamic model represented in FIG. 11 of the occupant and seat for the actively sprung car seat.

The continuously distributed foam of the seat cushion is approximated by concentrated stiffnesses and dampings in the directions normal and tangential to the surface, while a visco-elastic coupling in the normal direction is assumed for the backrest cushion. This produces at least two degrees of freedom for the model: on the one hand the lifting and pitching motion and on the other hand the lifting and rolling motion of the seat.

The models derived are implemented for the design of the closed-loop control system as a system of nonlinear state differential equations in the open-loop or closed-loop control electronics for the linear actuators.

Various exemplary embodiments of the vehicle seat according to the invention are explained in more detail below on the basis of figures, in which:

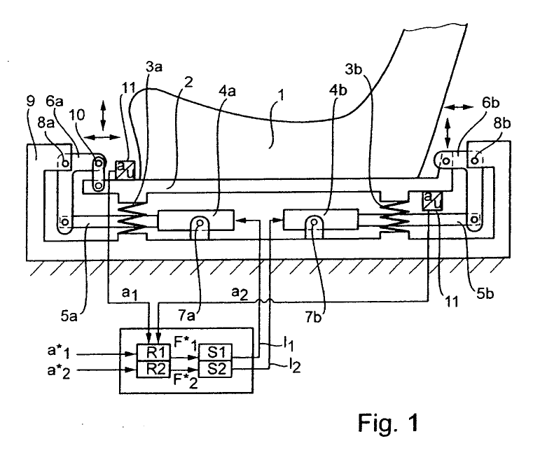

FIG. 1 shows an active seat suspension with two closed control loops;

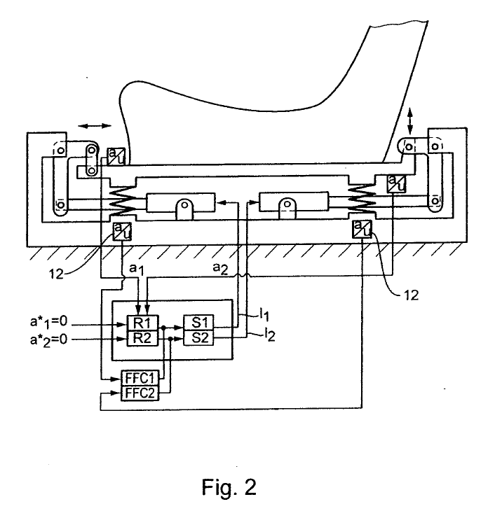

FIG. 2 shows an active seat suspension with two closed control loops and with feedforward control and feedforward compensation;

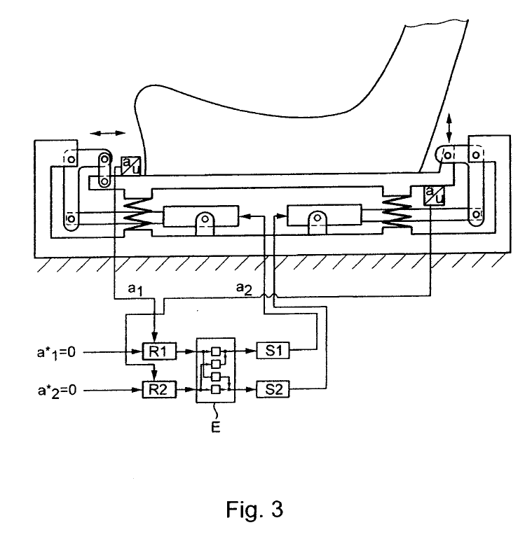

FIG. 3 shows an active seat suspension with two closed control loops and with a decoupling network for the two control loops;

FIG. 4 shows an active seat suspension with two closed control loops and with a decoupling network and feedforward control with feed forward compensation;

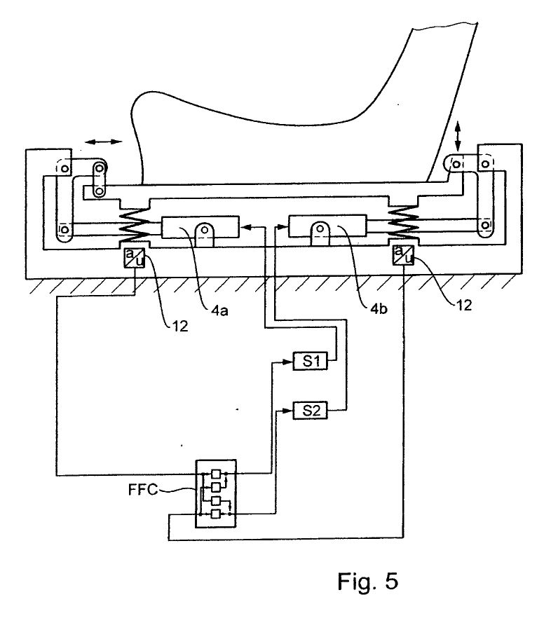

FIG. 5 shows an active seat suspension with two open-loop control systems and with feedforward control with allowance for coupling of the controlled systems;

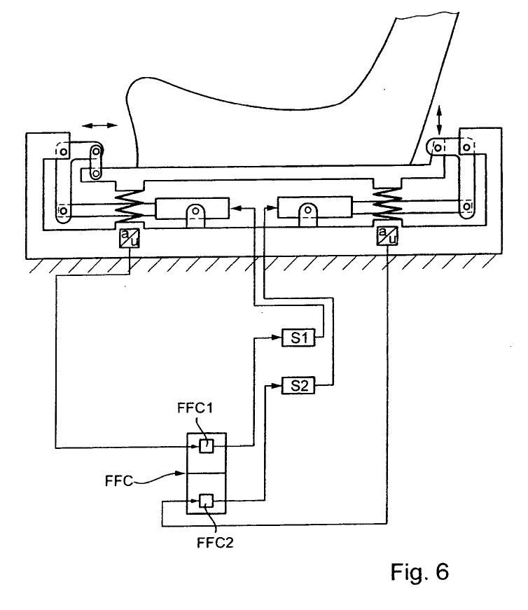

FIG. 6 shows an active seat suspension with two open-loop control systems and with feedforward control without allowance for coupling of the controlled systems;

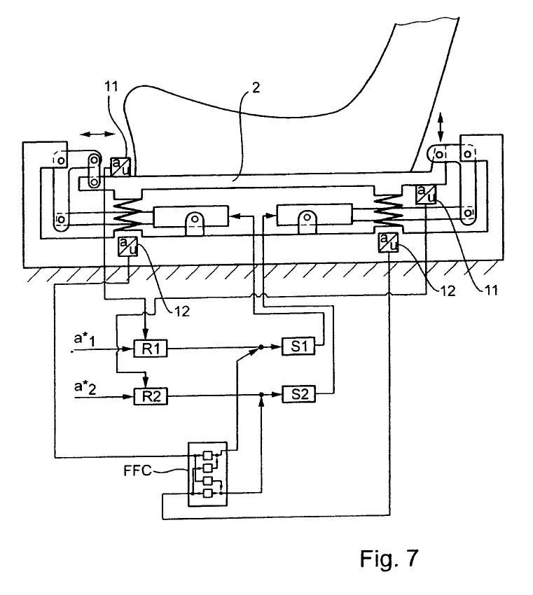

FIG. 7 shows an active seat suspension with two closed control loops and with feedforward control with allowance for coupling of the controlled systems;

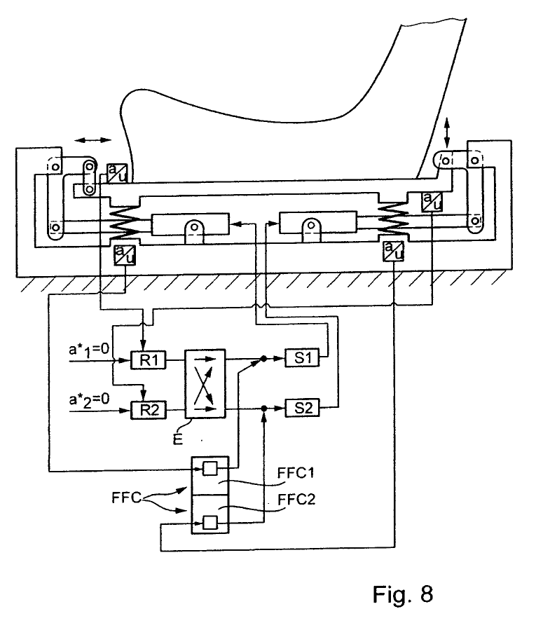

FIG. 8 shows an active seat suspension with two closed control loops and with a decoupling network and feedforward control, the feedforward control making no allowance for the coupling of the controlled systems;

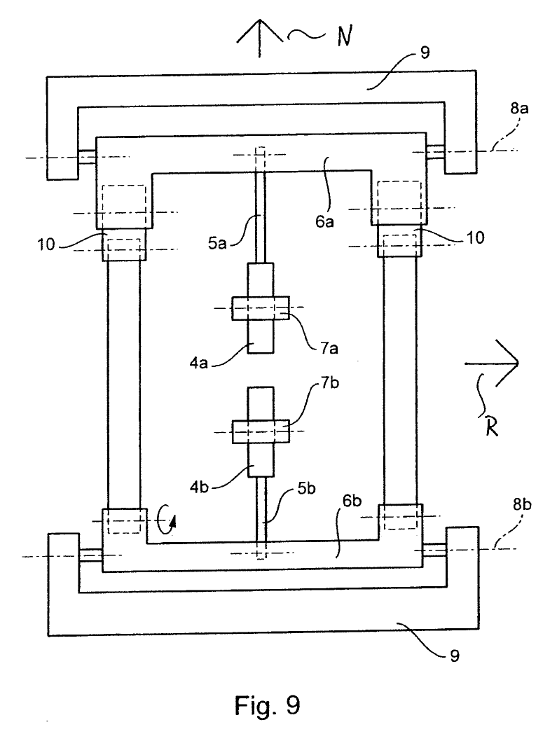

FIG. 9 shows a plan view of the seat mechanism with deflecting linkages, vibration-isolating frames and actuators arranged in a lying manner for the compensation of pitching motions or rolling motions, depending on the fitted position of the seat;

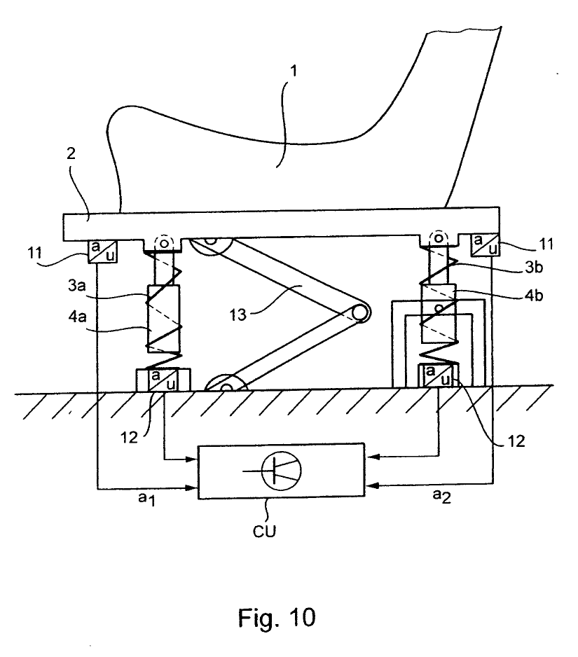

FIG. 10 shows an active seat suspension with actuators arranged in an upright manner;

FIG. 11 shows a mathematical seat model for the model-based closed-loop or open-loop control concepts.

The active seat suspension substantially comprises a vibration-isolating frame which can be adjusted by means of actuators, and the control and power electronics necessary for operating the actuators. The following exemplary embodiments use an identical seat mechanism in each case, for which reason the seat mechanism is described only once, in conjunction with FIGS. 1 and 9, for all the exemplary embodiments. The individual exemplary embodiments differ with regard to expenditure and quality concerning the closed-loop or open-loop control concepts for the actuators of the seat mechanism.

FIG. 1 shows an exemplary embodiment of the invention in its basic configuration. An upholstered driver's seat 1 is fastened on a vibration-isolating frame 2. The vibration-isolating frame is supported with respect to the underbody by a total of four springs 3a, 3b. A passive suspension and damping of the seat can be set and achieved by means of the spring constant and the damping constant of the springs. An active seat mechanism is superposed on the passive seat suspension comprising the spring mechanism and the seat upholstery. The active seat mechanism comprises the vibration-isolating frame 2, on which at least two actuators 4a, 4b are articulated. The actuators may in this case be driven electrically, pneumatically or hydraulically. Electric linear motors are preferably used as the final control elements for the seat mechanism. The actuators are preferably fitted as electric linear motors in a lying manner under the seat. In order to convert the horizontal linear movement of the actuator rods 5a, 5b into a vertical movement and also to convert a pitching movement of the passenger seat, the actuators are articulated on the vibration-isolating frame 2 of the passenger seat by means of a deflecting linkage.

A plan view of the deflecting linkage is outlined in FIG. 9. The deflecting linkage accordingly comprises a first angle piece 6a and a second angle piece 6b. An actuator rod is respectively articulated on the downwardly directed leg of the first and second angle pieces. The actuators 4a, 4b themselves are connected to the vehicle chassis via rotary bearings 7a, 7b. Similarly, the first angle piece and the second angle piece are connected to the seat suspension 9 on the chassis side via a rotary mounting 8a, 8b. The vibration-isolating frame 2 of the vehicle seat is articulated on the second leg of the angle pieces, the alignment of which is directed substantially horizontally and toward the seat. In the exemplary embodiment represented, the vibration-isolating frame is articulated on the second angle piece directly, while the vibration-isolating frame is articulated on the first angle piece via two compensating elements 10.

The compensating elements are necessary, inter alia, to allow compensation for the arcuate movement of the articulating points of the vibration-isolating frame in the horizontal direction when at least one of the two actuators is operated. Furthermore, the compensating elements allow not only a purely vertical compensating movement of the seat with respect to shocks of the vehicle chassis but also a compensation for the pitching or rolling movement of the seat, depending on the fitted position of the seat mechanism in relation to the direction of travel. The pitching or rolling movement of the seat is brought about by changes of varying degrees in the horizontal adjusting displacements of the actuator rods 5a, 5b. This also illustrates the two degrees of freedom of motion of the active seat suspension, namely the lifting movement on the one hand and the pitching or rolling movement on the other hand.

The first degree of freedom of motion is the Vertical upward and downward movement of the seat given uniform, vertical deflection of the horizontal legs of the two angle pieces. The deflection is brought about by adjusting displacements of the actuator rods made to match the lever ratios of the deflecting mechanism.

The second degree of freedom of motion is the mentioned pitching movement or rolling movement of the seat. A pitching movement occurs when there is differing vertical deflection of the front and rear points of articulation of the vibration-isolating frame 2. This pitching movement is also brought about by adjusting displacements of the actuator rods, which are transferred to the vibration-isolating frame of the vehicle seat in a way corresponding to the lever ratios of the deflecting mechanism.

A pitching movement about the transverse vehicle axis of the seat or its compensation is obtained with a fitted position of the seat corresponding to the alignment of the seat mechanism indicated by the arrow N. The arrow N indicates here the intended traveling direction of the vehicle.

A rolling movement about the longitudinal vehicle axis of the seat or its compensation is obtained with a fitted position of the seat rotated by 90° corresponding to the alignment of the seat mechanism indicated by the arrow R.

The seat mechanism previously described in conjunction with FIG. 1 and FIG. 9 is identical for the exemplary embodiments of FIGS. 2 to 8. The exemplary embodiments differ, however, in the open-loop and closed-loop control electronics for the two actuators of the seat mechanism.

The aim of the closed-loop control is to provide seating that is free from vibration. This means that the state variables of the seat are to be controlled to zero and the design of the closed-loop control system is to be optimized with respect to the disturbance characteristic. If the seat control system is integrated in a higher-level vehicle stability control system, the guiding of the seat movement on the basis of the desired values proves to be advantageous from ergonomic aspects, which is not considered in any more detail here.

The closed-loop control system is based on the model described in conjunction with FIG. 11. By suitable linearizations on the one hand and technical control measures to compensate largely for the inherent couplings between the degrees of freedom on the other hand, it is possible to parameterize the part-modules required for the control, viz. controller R1, controller R2, final control element S1, final control element s2, feedforward control by feedforward compensation FFC1, FFC2 and decoupling network E.

Since, in the case of the respective part-state controller R1, R2, not only the acceleration but also the speed and position are returned, the speed and position can be generated from the acceleration signal of the acceleration sensors 11 on the vibration-isolating frame 2 by approximating integration. Of decisive significance in this case for the overall dynamics of the control system is the frequency of the high-pass filtering required for this (to avoid divergent integrations caused by offsets that are virtually always present). With the “cutoff frequency” parameter, the dynamic vibrational suppression of the active seat suspension is delimited from that of the chassis. The cutoff frequencies can be chosen differently for each degree of freedom. Because of the delimitation of the maximum available actuator force and the vibration displacement limited by the installation space, these frequencies are fixed at 2 Hz for car seat control. Moreover, a lower frequency is not ergonomically advisable, since the seat control then counteracts to a great extent the occupant's own movements, which has a highly adverse effect on the expected feeling of the seat. Wherever there are still reserves of force and vibration displacement, improved suppression of the low-frequency disturbances can be achieved by the feedforward control FFC allowed for in the concept, using the console acceleration, measured by the additional acceleration sensors 12 on the bottom of the console.

The actuators are respectively activated by electronic final control elements S1, S2. The control commands for the actuators are determined on a model basis. The adjusting displacements of the actuators must be calculated by means of a microcomputer in a way corresponding to the dimensions of the constructional model of the seat mechanism and converted into control commands for the actuators.

In the case of the embodiment that is shown in FIG. 1, this takes place for example in the microcomputer modules of the two controllers R1 and R2. For this purpose, the first controller R1 is connected to the first acceleration sensor 11a and to the first final control element S1 for the activation of the first actuator 4a. The signal of the first acceleration sensor is the controlled variable a1 for the controller. A correcting adjusting force F*1 is determined from the controlled variable a1 and the prescribed reference variable a*1=0 on a model basis. In the final control element, the required current i1 for driving the actuator is then determined from the correcting adjusting force F*1. An analogous procedure is followed for the second control loop, comprising the second controller R2, the second final control element S2, the second actuator 4b and the second acceleration sensor 11b at the rear spring supporting point of the vibration-isolating frame 2. Prescribed to the controller as the reference variable is the acceleration value a*2, which is intended to have the value zero. A correcting adjusting force F*2 is calculated from the deviation from the reference variable and the acceleration a2 measured as the controlled variable at the rear spring supporting point on a model basis in the controller R2 and used to determine in the final control element S2 the current value i2 for the required adjustment of the actuator.

The exemplary embodiment of FIG. 2 extends the basic configuration of the exemplary embodiment discussed in conjunction with FIG. 1 by adding a simple feedforward control FFC1, FFC2 in the form of a feedforward compensation, separately for each closed control loop. For this purpose, the mechanical construction of the seat is provided with two additional acceleration sensors 12. The additional acceleration sensors are located on the console of the vehicle chassis at the spring supporting point of the seat suspension and measure the accelerations or forces introduced into the seat substructure from the vehicle chassis. The signals of these two additional sensors are fed on the input side to a feedforward control FFC, which is formed as a so-called feedforward compensation. Each control loop receives an independent feedforward control of its own, the output of which is respectively connected to the summation point on the input side between the two controllers R1 and R2 on the one hand and the two final control elements S1 and S2 on the other hand. The aim of the feedforward control formed as feedforward compensation is to be able to detect introduced disturbances as early as possible and take countermeasures before there is any response by the seat mechanism with its mass moment of inertia.

Starting out from the exemplary embodiment of FIG. 1, the comfort of the active seat suspension can be improved if the two controlled systems of the control loops are decoupled by an decoupling network E, as outlined in FIG. 3. With the decoupling network, the couplings of the two degrees of freedom of motion of the seat mechanism are eliminated by computational means. The compensation result is then physically integrated into the control concept by means of suitable electronic circuits. This decoupling network E uses here the output variables of the two controllers R1 and R2 and converts the desired manipulated variables into coupling-free manipulated variables for the downstream final control elements S1 and S2 of the seat actuator system.

The most comprehensive embodiment of the invention is represented by the exemplary embodiment of FIG. 4. Here, a multi-variable state control, which largely isolates the seat in its two degrees of freedom from the introduced disturbances, is used for the closed-loop control of the actively suspended seat. Therefore, in the preferred embodiment corresponding to FIG. 4, a controller and a final control element are provided for each degree of freedom of motion, the two controlled loops additionally being decoupled by a decoupling network and the final control elements having an additional feedforward control, which for its part likewise allows for the coupling of the two degrees of freedom of motion.

A first controller R1 is connected to a first acceleration sensor 11a at the front spring supporting point. The signal of the acceleration sensor is the controlled variable a1 for the first controller. The controller receives the acceleration value a*1, prescribed as the reference variable. The reference variable of the acceleration is to be zero.

In an analogous way, the second controller R2 is connected to the second acceleration sensor 11b on the vibration-isolating frame at the rear spring supporting point. The signal of the sensor is the controlled variable a2 for the second controller R2. This controller also receives the acceleration value zero, prescribed as the reference variable a*2.

The dynamic forces introduced from the console of the vehicle chassis into the spring supporting points on the console side are likewise measured by an additional first and second acceleration sensor 12a, 12b. These additional acceleration sensors are arranged at the spring supporting point on the console side. Signals of these additional acceleration sensors are passed on to a feedforward control FFC as output variables. The feedforward control comprises a feedforward compensation with allowance for the coupling of the two controlled systems of the seat mechanism. By means of model-based algorithms, a correcting adjusting force counteracting the relevant disturbance is calculated in the computing modules of the feedforward control for each final control element S1 and S2 in relation to the forces measured in the console and is passed as a manipulated variable to a summation point at the respective input of the final control element.

Between the two controllers R1 and R2 and the two final control elements S1 and S2 for activating the two linear actuators 3a, 3b there is an decoupling network E. With the decoupling network, the inherent couplings of the two control systems are decoupled. The two controlled systems for the vertical movement of the vibration-isolating frame and for the pitching movement of the vibration-isolating frame are decoupled via the two rotary mountings of the angle pieces. To be able to perform the vertical movement without feedback on the pitching movement of the vibration-isolating frame, and vice versa, the two degrees of freedom of motion must be decoupled. This takes place with the decoupling network E. On the output side of the decoupling network, the two manipulated variables decoupled with respect to the controlled variables are then available for the final control elements of the two linear actuators. These manipulated variables are likewise passed to the two summation points on the input side of the two final control elements. In the final control elements, the necessary currents for adjusting the force-current-controlled linear actuators are determined from the summated manipulated variables from feedforward control and decoupled controller manipulated variables F*1, F*2, and passed to the linear actuators. Finally, an opposing movement of the seat is introduced by this process in two degrees of freedom of motion, the opposing movement counteracting a movement of the seat introduced from the console.

The exemplary embodiment of FIG. 5 shows a simplified embodiment of the active seat suspension according to the invention. As a difference from the aforementioned embodiments, the exemplary embodiment of FIG. 5 dispenses with a closed-loop control. The embodiment of this active seat suspension again includes the seat mechanism of all the previously mentioned embodiments, but the seat actuators are operated merely with an open-loop control system with feedforward control FFC. Closed-loop control of the actuators of the seat mechanism is not included here. The open-loop control here comprises the two final control elements S1 and S2 for the two actuators 4a, 4b and also the feedforward control FFC, which is formed as feedforward compensation. The signals of two acceleration sensors 12a, 12b are taken as the input disturbances for the feedforward control. The two acceleration sensors are attached to the console of the vehicle chassis at the spring supporting points of the seat mechanism and sense the accelerations or dynamic forces introduced into the seat mechanism from the console. The feedforward control or feedforward compensation includes computational allowance for the coupling of the controlled systems. Counteracting adjusting forces are calculated on a model basis from the signals of the two acceleration sensors, are passed on the input side to the final control elements of the seat actuators and are converted by the final control elements into currents for operating the actuators.

The exemplary embodiment of FIG. 6 shows a further simplification of the invention in comparison with the embodiment shown and described in FIG. 5. The simplification is contained in the feedforward control FFC. In the case of this exemplary embodiment, the feedforward control does not include any allowance for the coupling of the controlled systems. A feedforward compensation is carried out separately for each final control element. The dynamic forces introduced into the seat mechanism from the console are compensated. These disturbing forces are measured by an acceleration sensor 12 respectively at the front spring supporting point and the rear spring supporting point of the console and converted by the two feedforward control modules FFC1 and FFC2 into virtual correcting adjusting forces for the final control elements. The final control elements calculate from the virtual adjusting forces the electric currents necessary for the associated actuator movements.

A further exemplary embodiment of the invention is outlined in FIG. 7. This embodiment represents a simplification of the preferred embodiment that is shown in FIG. 4. The seat mechanism is once again identical to the exemplary embodiments already described above. The control concept provides two controllers R1 and R2, two final control elements S1 and S2 and a feedforward control FFC with allowance for the coupling of the controlled systems. As a difference from the exemplary embodiment of FIG. 4, the exemplary embodiment of FIG. 7 dispenses with a decoupling network. In other words, this produces the following control concept:

With a first, front acceleration sensor 11a at the front spring supporting point of the vibration-isolating frame 2 and a second, rear acceleration sensor 11b at the rear spring supporting point of the vibration-isolating frame 2, the two-dimensional movement of the spring-isolating frame is sensed. The signal of the first acceleration sensor is passed as a controlled variable to the first controller. The signal of the second acceleration sensor is passed as a controlled variable to the second controller R2. Both controllers receive the acceleration value zero, prescribed as a reference variable. A counteracting virtual adjusting force is determined from the controlled variable and the reference variable in each controller and transmitted to the respectively following summation point of the respectively following final control element S1 and S2. With two additional acceleration sensors 12 on the console of the vehicle chassis, the forces introduced into the seat mechanism from the console are determined. For this purpose, an additional front acceleration sensor is arranged at the front spring supporting point of the console and a second additional acceleration sensor is arranged at the rear spring supporting point of the console. The signals of these two additional acceleration sensors 12 are passed to the input of the feedforward control FFC. In the feedforward control, virtual, compensatory forces are calculated on a model basis by means of a feedforward compensation, with allowance for the coupling of the controlled systems, and are likewise also passed to the summation points of the downstream final control elements. The compensatory, virtual forces act in a compensatory manner in relation to the forces introduced into the seat mechanism from the console as dynamic disturbing forces. In the final control elements, the summated, virtual adjusting forces are used to determine the associated operating current for the actuator assigned to the respective final control element, and finally the respective actuator is operated with this current.

A further simplified variant of the preferred embodiment that is shown in FIG. 4 is outlined in FIG. 8. In this exemplary embodiment also, the seat mechanism is identical to the previously described exemplary embodiments. For each degree of freedom of motion of the seat mechanism, the control concept comprises a control chain, made up in each case of a controller R1, R2 and in each case a final control element S1, S2, the controlled systems between the two controllers and the two final control elements being decoupled by means of a decoupling network E. In addition to the decoupling network, the control concept of the embodiment that is shown in FIG. 8 also includes a feedforward control FFC. As a difference from the embodiment that is shown in FIG. 4, the feedforward control in the embodiment that is shown in FIG. 8 includes two separate feedforward compensations, which make no allowance for the coupling of the controlled systems.

With a first, front acceleration sensor 11a at the front spring supporting point of the vibration-isolating frame 2 and a second, rear acceleration sensor 11b at the rear spring supporting point of the vibration-isolating frame 2, the two-dimensional movement of the spring-isolating frame is sensed. The signal of the first acceleration sensor is passed as a controlled variable to the first controller R1. The signal of the second acceleration sensor is passed as a controlled variable to the second controller R2. Both controllers receive the acceleration value zero, prescribed as a reference variable. A counteracting, virtual adjusting force is determined from the controlled variable and the reference variable in each controller and transmitted to the downstream decoupling network E. In the decoupling network, the movement equations for the seat mechanism are computationally decoupled and converted into coupling-free desired adjusting forces. These desired adjusting forces are transmitted to the respectively following summation point of the respectively following final control element S1 and S2. With two additional acceleration sensors 12a, 12b on the console of the vehicle chassis, the forces introduced into the seat mechanism from the console are determined. For this purpose, an additional front acceleration sensor is arranged at the front spring supporting point of the console and a second additional acceleration sensor is arranged at the rear spring supporting point of the console. The signal of the first additional acceleration sensor 12 is passed to the input of the first feedforward control FFC1. The signal of the second additional acceleration sensor 12 is passed to the input of the second feedforward control FFC2. In the two modules FFC1, FFC2 of the feedforward control, virtual, compensatory forces are calculated on a model basis by means of a feedforward compensation and are likewise passed to the summation points of the downstream final control elements. The compensatory, virtual forces act in a compensatory manner in relation to the forces introduced into the seat mechanism from the console as dynamic disturbing forces. In the final control elements, the summated, virtual adjusting forces are used to determine the associated operating current for the actuator assigned to the respective final control element, and finally the respective actuator is operated with this current.

FIG. 10 illustrates a group of exemplary embodiments of the invention which can be operated with each of the 8 different control concepts of the previously described exemplary embodiments that are shown in FIGS. 1 to 8. However, these eight different control concepts are combined with a modified seat mechanism, that is to say with a seat mechanism in which the actuators are arranged in an upright manner. This of course requires more overall space in terms of height, so that the seat mechanism is less suitable for use in passenger vehicles. In commercial vehicles, however, the upright arrangement of the actuators offers the advantage that a greater active spring displacement is made possible in the vertical direction in comparison with the seat mechanism corresponding to FIG. 1.

In the embodiment of the invention that is suitable for commercial vehicles, the seat is arranged on a vibration-isolating frame 2. The vibration-isolating frame is articulated on the console of the vehicle chassis by at least two spring-leg actuators. The spring-leg actuators in this case respectively comprise the actual actuator 4a, 4b and the spring leg 3a, 3b. A scissors-joint mechanism 13 provides the lateral stability of the seat mechanism. Respectively arranged at the front and rear spring supporting points on the vibration-isolating frame and on the console are acceleration sensors 11, 12, which are identical in their function and effect to the corresponding, previously described acceleration sensors of the exemplary embodiments 1 to 8. Electronics generally represented as closed-loop/open-loop control unit CU undertake the sensor data processing and the closed-loop or open-loop control of the actuators of the seat mechanism. All eight different variants of the closed-loop and open-loop control, as they are described from the exemplary embodiments of FIGS. 1 to 8, may be used. The individual controllers, final control elements, feedforward controls and decoupling networks are grouped together in a one-piece power and control electronics unit CU, as they are incidentally also in the exemplary embodiments of FIGS. 1 to 8.

There is no separate diagram of the extension of the seat mechanism and the control electronics to a seat system with more than two degrees of freedom. Although tests have shown that the two degrees of freedom of motion, viz. vertical adjustment and pitching movement of the seat, are the movements that are subjectively significant for the driver, the seat mechanism presented here can be extended by adding additional degrees of freedom of motion, for example by means of a compound table arrangement on which the entire seat mechanism is arranged, so that even three or more degrees of freedom of motion to be controlled are possible for an actively sprung vehicle seat. The open-loop or closed-loop control concept is then respectively extended by adding the additional degrees of freedom of motion in a way analogous to the 8 different concepts presented here.

1. A vehicle seat provided with an active suspension, comprising:
a vibration-isolating frame (2) resiliently mounted by means of spring supporting points,
a seat mechanism (6a, 6b, 8a, 8b, 10, 13), which can be adjusted by means of at least two actuators (4a, 4b) and is articulated on the vibration-isolating frame (2),
at least two acceleration sensors (11, 12), of which the first acceleration sensor is arranged at a spring supporting point in the vicinity of a first joint axis, and the second acceleration sensor is arranged at a spring supporting point in the vicinity of a second joint axis, and
at least two final control elements (S1, S2) and power and control electronics (R1, R2, FFC, E, CU) with which the signals of the acceleration sensors are processed and converted into desired adjusting forces (F*1, F*2), which serve as control commands for the final control elements (S1, S2) for operating the actuators (4a,4b),
characterized in that
the vibration-isolating frame (2) can be adjusted by means of the two actuators (4a, 4b) in at least two degrees of freedom of motion, and the forces which are introduced into the seat from the console of the vehicle chassis are compensated by means of the power and control electronics (R1, R2, FFC, E, CU) in at least two degrees of freedom of motion.

2. The vehicle seat as claimed in claim 1, characterized in that the actuators (4a, 4b) are linear actuators and are arranged under the vibration-isolating frame (2) in a lying manner.

3. The vehicle seat as claimed in claim 1, characterized in that the actuators (4a, 4b) are linear actuators and are arranged under the vibration-isolating frame (2) in an upright manner.

4. The vehicle seat as claimed in claim 1, characterized in that the actuators are either electrical actuators, electromagnetic actuators, pneumatic actuators or hydraulic actuators.

5. The vehicle seat as claimed in claim 1, characterized in that the power and control electronics realize a control loop (R1, S1, R2, S2) for each degree of freedom of motion.

6. The vehicle seat as claimed in claim 1, characterized in that two additional acceleration sensors (12) for feedforward control are included and in that the power and control electronics include for each degree of freedom of motion a closed-loop control system (R1, S1, R2, S2) with feedforward control (FFC1, FFC2), without allowance for coupling of the controlled systems.

7. The vehicle seat as claimed in claim 1, characterized in that the power and control electronics realize for each degree of freedom of motion a control loop (R1, S1, R2, S2), the two control loops being decoupled by a decoupling network (E).

8. The vehicle seat as claimed in claim 1, characterized in that two additional acceleration sensors (12) for feedforward control are included and in that the power and control electronics include for each degree of freedom of motion a control loop (R1, S1, R2, S2), the two control loops being decoupled by a decoupling network (E), and the control including an additional feedforward control (FFC), with allowance for the coupling of the controlled systems.

9. The vehicle seat as claimed in claim 1, characterized in that the power and control electronics include for each degree of freedom of motion a final control element (S1, S2) which is activated on the input side by means of a feedforward control (FFC), without allowance for the coupling of the controlled systems.

10. The vehicle seat as claimed in claim 1, characterized in that the power and control electronics include for each degree of freedom of motion a final control element (S1, S2) which is respectively activated on the input side by a separate feedforward control (FFC1, FFC2) of its own, without allowance for the coupling of the controlled systems.

11. The vehicle seat as claimed in claim 1, characterized in that two additional acceleration sensors (12) are included for the feedforward control, and in that the power and control electronics realize for each degree of freedom of motion a control loop (R1, S1, R2, S2) with additional feedforward control (FFC), with allowance for the coupling of the controlled systems.

12. The vehicle seat as claimed in claim 1, characterized in that two additional acceleration sensors (12) are included for the feedforward control, and in that the power and control electronics realize for each degree of freedom of motion a control loop (R1, S1, R2, S2), the two control loops being decoupled by a decoupling network (E), and the control including for each degree of freedom of motion an additional feedforward control (FFC1, FFC2) of its own, without allowance for the coupling of the controlled systems.

13. The vehicle seat as claimed in claim 6, characterized in that the feedforward control (FFC, FFC1, FFC2) is a feedforward compensation.

14. The vehicle seat as claimed in claim 1, characterized in that the position of the joint axes is chosen such that not only the lifting movement of the seat but also a pitching movement of the seat about the transverse vehicle axis is compensated.

15. The vehicle seat as claimed in claim 1, characterized in that the position of the joint axes is chosen such that not only the lifting movement of the seat but also a rolling movement of the seat about the longitudinal vehicle axis is compensated.

16. The vehicle seat as claimed in claim 1, characterized in that progressively acting springs (3a, 3b) are arranged at the spring supporting points.

17. The vehicle seat as claimed in claim 16, characterized in that the progression of the springs is chosen in such a way that the natural frequency of the mass-spring system comprising the seat and the springs (3a, 3b) is largely independent of the weight loading by a passenger.

18. The vehicle seat as claimed in claim 16, characterized in that the natural frequency of the spring-mass system comprising the passenger plus the seat and springs (3a, 3b) in a passenger car is in the range from 3 to 5 Hertz, preferably in the range from 3.8 to 4.5 Hertz, or in that the natural frequency of the spring-mass system comprising the passenger plus the seat and springs (3a, 3b) in a commercial vehicle lies in the range from 1 to 3 Hertz, preferably in the range from 1.2 to 1.8 Hertz.

19. The vehicle seat as claimed in claim 1, characterized in that the activation and control of the actuators is carried out on the basis of a mathematical model of the human body on a seat mounted in a resilient and damping manner.
